(19) United States
(12) Patent Application Publication
(10) Pub. No.: US 2020/0364806 A1
(43) Pub. Date: Nov. 19, 2020

(54) SYSTEMS AND METHODS FOR INITIATING CONVERSATIONS WITHIN AN ONLINE DATING SERVICE

(71) Applicant: Facebook, Inc., Menlo Park, CA (US)

(72) Inventors: Qiang Wang, Redwood City, CA (US); Nathan Andrew Sharp, San Francisco, CA (US)

(21) Appl. No.: 16/736,178

(22) Filed: Jan. 7, 2020

Related U.S. Application Data
(60) Provisional application No. 62/847,975, filed on May 15, 2019.

(51) Int. Cl. G06Q 50/00; H04L 12/58

(52) U.S. Cl. CPC G06Q 50/01; H04L 51/32; H04L 51/02

(57) ABSTRACT

A computer-implemented method for initiating conversations within an online dating service may include identifying a potential match for a user of an online dating service, automatically generating, in response to identifying the potential match, a customized interactive ice breaker widget that is customized to facilitate conversation between the user and the potential match, presenting the customized interactive ice breaker widget to the user, obtaining the user's response to the customized interactive ice breaker widget, and presenting, to the potential match, both the customized interactive ice breaker widget and the user's response to the customized interactive ice breaker widget to facilitate conversation between the user and the potential match. Various other methods, systems, and computer-readable media are also disclosed.

### CROSS-REFERENCE TO RELATED APPLICATION

This application claims priority to and the benefit of U.S. Provisional Application No. 62/847,975, which is entitled “SYSTEMS AND METHODS FOR INITIATING CONVERSATIONS WITHIN A COMMUNITY-BASED DATING SERVICE,” and was filed on May 15, 2019, the entire contents of which are incorporated herein by reference.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for initiating conversations within an online dating service.

FIG. 2 is a flow diagram of an exemplary method for initiating conversations within an online dating service.

FIG. 3 is an illustration of an exemplary interactive ice breaker widget designed to facilitate conversations between matches in an online dating service.

FIG. 4 is an illustration of potential exemplary interactive ice breaker widgets that can be presented to users of an online dating service.

FIG. 5 is an illustration of an exemplary interactive ice breaker widget during an initial phase of interaction.

FIG. 6 is an illustration of an exemplary interactive ice breaker widget from the perspective of a user receiving the widget.

FIG. 7 is an illustration of an exemplary interactive ice breaker widget that has been interacted with by a pair of users.

FIG. 8 is an illustration of an exemplary interactive ice breaker widget during an alternative initial phase of interaction.

FIG. 9 is a flow diagram of an exemplary method for initiating conversations within an online dating service.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

The Internet has revolutionized how people connect to and communicate with each other. For example, many couples now meet via online dating sites and applications rather than in person or through mutual friends. Unfortunately, it can sometimes be difficult for users of an online dating service to initiate new relationships.

For example, an online dating service may facilitate dating connections by matching participants with one another based on a variety of factors such as common interests, mutual friends, or other attributes. However, even within such services, it may be difficult, cumbersome, or awkward for participants to initiate conversations with each other once matched. Because of this, participants who are matched with each other may never start a conversation, rendering the match fruitless.

The present disclosure is generally directed to systems and methods for initiating conversations within an online dating service. In one example, the disclosed systems may generate a conversation initiation message (also referred to as a “customized interactive ice breaker widget,” “ice breaker,” “ice breaker message,” and/or “ice breaker question” herein) and may present the conversation initiation message to a participant in an online dating service and/or to a potential match of the participant within the community-based dating service. The conversation initiation message may, for example, include a question or inquiry posed to the participant and/or to the potential match that may be framed to encourage formation of a conversation or relationship with an additional participant. For example, an ice breaker message may include a question framed to encourage disclosure by the participant of information about common interests of the participant and the potential match.

By generating and presenting an ice breaker message (e.g., an ice breaker question, an ice breaker image, an ice breaker media item, etc.) to a participant in an online dating service and/or to a potential match of the participant in the community-based dating service, the systems and methods described herein may reduce and/or alleviate a real or perceived social disincentive for the participant to initiate a conversation with the potential match. For example, the systems and methods described herein may provide a fun and lightweight experience by inviting the participant and the potential match to answer the same question as part of an initial conversation. This may further enable the participant and the potential match to start building a meaningful relationship from this simple initial interaction.

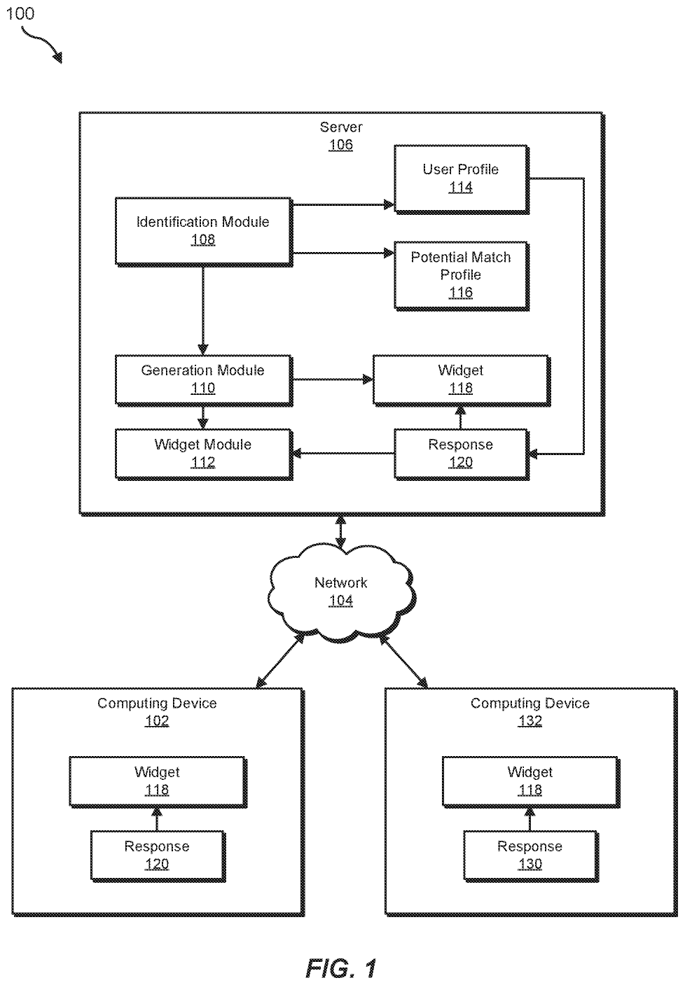

In some embodiments, the systems described herein may operate on a client-server architecture. FIG. 1 is a block diagram of an exemplary system 100 for initiating conversations within an online dating service. In one embodiment, and as will be described in greater detail below, a server 106 may be configured with an identification module 108 that may identify a user profile 114 of an online dating service and/or a potential match profile 116 for user profile 114. Although illustrated as a single server, in some embodiments server 106 may represent multiple servers hosted in one or more data centers (e.g., cloud servers). In some examples, a generation module 110 may generate a widget 118 to facilitate conversation between a user associated with user profile 114 and a user associated with potential match profile 116. In one example, a widget module 112 may present widget 118 to the user associated with user profile 114, obtain a response 120 from the user associated with user profile 114, and/or present widget 118 and/or response 120 to the user associated with potential match profile 116. In some embodiments, a computing device 102 associated with a user of user profile 114 may display widget 118 and/or receive response 120 as input. Additionally or alternatively, a computing device 132 associated with a user of potential match profile 116 may display widget 118 and/or receive response 130 as input. Computing devices 102 and/or 132 may represent a mobile device, a desktop device, a wearable device, and/or any other type of suitable personal computing device. In some embodiments, computing device 102 may communicate with server 106 and/or computing device 132 via a network 104. Although illustrated as a single network, in some embodiments network 104 may represent multiple networks, including but not limited to a local area network, a wide area network, a cellular network, and/or the Internet.

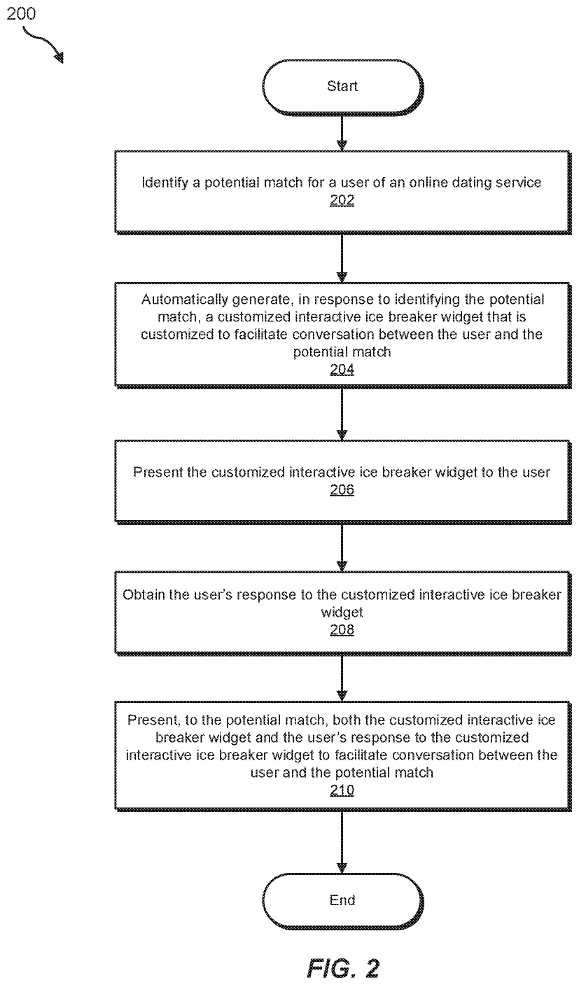

FIG. 2 is a flow diagram of an exemplary method 200 for initiating conversations within an online dating service via a customized interactive ice breaker widget. In some examples, at step 202, the systems described herein may identify a potential match for a user of an online dating service. For example, identification module 108 in FIG. 1 may, as part of server 106, identify a potential match between a user associated with user profile 114 and a user associated with potential match profile 116.

In some examples, an “online dating service” may refer to any service that manages dating connections and/or shares, compiles, formats, and/or broadcasts information based on dating connections. In one example, this dating service may represent a feature of a social networking system that also facilitates non-dating-based connections. In this example, the social networking system may only identify and surface potential matches to participants that have proactively opted in to the dating service provided by the social networking system (i.e., participants in a social networking system may only become participants in a dating service provided by the social networking system by proactively opting in to the dating service).

In some cases, the online dating service may also represent a community-based online dating service and/or a community-based dating service of a social networking system. The terms “community-based dating service,” a “community-based dating service of a social networking system,” and/or a “community-based dating service associated with an interest-based community” may, in some cases, represent a feature of a social networking system that facilitates (e.g., establishes, promotes, furthers, expedites, provides tools for, etc.) formation, maintenance, and/or dissolution of dating connections between members of interest-based communities. For example, a community-based dating service and/or feature may identify and match members of an interest-based community who are participants in a dating service of a social networking system to other members of the interest-based community who are also participants in the dating service of the social networking system. This may enable users who share common interests (e.g., users who are both members of an interest-based community) to form dating connections with each other. For example, the systems described herein may detect that a user who has opted into the dating service is a member of an “I love golden retrievers” group and may surface other members of the “I love golden retrievers” group who have opted into the dating service to the user as potential matches. Additionally or alternatively, the systems described herein may surface as potential matches users of the dating service who list golden retrievers and/or dogs as interests in their profiles.

By facilitating dating connections between users who already share common interests, a community-based dating feature of a social networking system may enable users to form strong, enjoyable, and valuable dating connections with other users of the social networking system more efficiently than via conventional electronic dating systems. As with prior examples, in some cases participants in a community-based dating service of a social networking system may only become participants in the dating service of the social networking system by proactively opting in to the dating service.

The systems described herein may identify a potential match for a user of a dating service in a variety of ways. In some embodiments, users of an online dating service may proactively seek out and identify potential matches among other users of the dating service (by, e.g., browsing and selecting user profiles). In these embodiments, a user may proactively identify and select a potential match. Additionally or alternatively, a social-networking-based dating service may guide users towards potentially compatible users via a variety of approaches that leverage the social-networking-based nature of the system. For example, a social-networking-based service may identify potential matches based on any suitable criteria including, without limitation, the geographic location of a participant, the dating status of the participant (e.g., “single”), a set of communities within the social networking systems of which the additional participant is a member, a compatibility score of the participant with an additional participant within the dating service, and so forth. In some examples, these participants may be referred to as “matches” or “potential matches” of the user within the dating service.

Returning to FIG. 2, at step 204 the systems described herein may automatically generate, in response to identifying the potential match, a customized interactive ice breaker widget that is customized to facilitate conversation between the user and the potential match. For example, generation module 110 may, as part of server 106, generate a widget 118 designed to facilitate conversation between the user associated with user profile 114 and the user associated with potential match profile 116.

In some examples, the terms “customized interactive ice breaker widget,” “ice breaker widget,” or “widget,” as used herein, may generally refer to any component of an online dating service that is designed to facilitate conversation between participants in a dating service. In some embodiments, the systems described herein may display an ice breaker widget in a private messaging channel between two users (as opposed to, e.g., on a user's profile) and/or may only display the response(s) provided to the widget to a pair of matched users. In some examples, a widget may include a text prompt in the form of an open-ended question. For example, a widget may include the prompt, “What was the first CD you ever owned?” In addition, a widget may store a response to the prompt for later display. In some examples, the systems described herein may present a widget to a pair of matched users and may display each user's response to the other. In some embodiments, each instance of a widget may store unique response information. For example, a user may be matched with a first potential match and input a first response into a first instance of a widget. That same user may later be matched with a second potential match and may input a second response into a second instance of the widget. In this example, the first potential match may be the only potential match who is able to view the first response and the second potential match may be the only potential match who is able to view the second response. In some embodiments, a widget may have multiple possible prompts and different instances of the widget may display different prompts. Additionally or alternatively, a single widget may be associated with a single prompt and the systems described herein may store multiple different widgets.

The systems described herein may generate customized interactive ice breaker widgets in a variety of ways. In some embodiments, the systems described herein may generate the widget automatically (without user interaction) in response to identifying the match. For example, the systems described herein may select a widget from a list of widgets automatically in preparation for presenting the widget to the match. Additionally or alternatively, the systems described herein may generate the widget automatically in response to the user taking an action related to the match, such as opening a conversation window, viewing the match, selecting the match, requesting the generation of a widget, and/or any other relevant action. In some embodiments, the systems described herein may select a customized widget and/or customize a widget by selecting a prompt for the widget that is relevant to a characteristic of the user. For example, the systems described herein may select or customize a widget that matches a category of interest identified on a user's profile. Additionally or alternatively, the systems described herein may generate a list of widgets to present to the user. In some embodiments, one or more servers associated with a dating service may generate a widget.

At step 206, the systems described herein may present the customized interactive ice breaker widget to the user. For example, widget module 112, as part of server 106, may present widget 118 to the user associated with user profile 114. In one example, the systems described herein may display the customized interactive ice breaker widget in a private messaging channel between the user and the potential match. In some embodiments, the customized interactive ice breaker widget may only be visible to the user and/or the potential match and may not be visible to other users of the dating service. In some embodiments, the systems described herein may present a list of customized interactive ice breaker widgets to the user and/or allow the user to ask the system generate a new customized interactive ice breaker widget. In some examples, the systems described herein may present the customized interactive ice breaker widget to the user by causing a device associated with the user (e.g., a mobile device) to display the widget. For example, the systems described herein may cause a dating application and/or social networking application on the user's mobile phone to display the widget when the user opens the private messaging channel with the potential match. In some embodiments, the systems described herein may present the widget simultaneously to the user and the potential match without waiting for input from the user. In one embodiment, the systems described herein may automatically present the widget to the user and the match upon generating the widget.

At step 208, the systems described herein may obtain the user's response to the customized interactive ice breaker widget. In some embodiments, the widget may include an open-ended question and the user's response may include text. Additionally or alternatively, the user's response may include emoticons, images, animations (e.g., gifs), and/or other media. For example, the widget may include a prompt of “describe yourself with five emojis,” and the systems described herein may obtain a response of “:) :D BD ;) :P” from the user. In some embodiments, the systems described herein may obtain the response via a device associated with the user and/or may store the response on a server.

At step 210, the systems described herein may present, to the potential match, both the customized interactive ice breaker widget and the user's response to the customized interactive ice breaker widget to facilitate conversation between the user and the potential match. For example, widget module 112, as part of server 206, may present widget 118 and response 120 to a user associated with potential match profile 116. For example, the systems described herein may present a widget with the prompt, “What would your indie band be named?” to the potential match and may also present the potential match with the user's response of, “The Malicious Toasters.”

In some embodiments, the systems described herein may present the widget with the prompt to the potential match but may not present the user's response to the potential match until the potential match has input a response to the widget. In some embodiments, the systems described herein may store the widget and the user's response on a server and may present the widget and/or the user's response to the potential match by causing a device associated with the potential match (e.g., a mobile device) to display the widget and/or the user's response. In some embodiments, the systems described herein may alert the potential match that the user has sent the potential match a widget and/or that the user has responded to the widget. Additionally or alternatively, the systems described herein may alert the user when the potential match responds to the widget. For example, the systems described herein may send a message, an out-of-band message (e.g., an email), and/or a notification to the user and/or potential match.

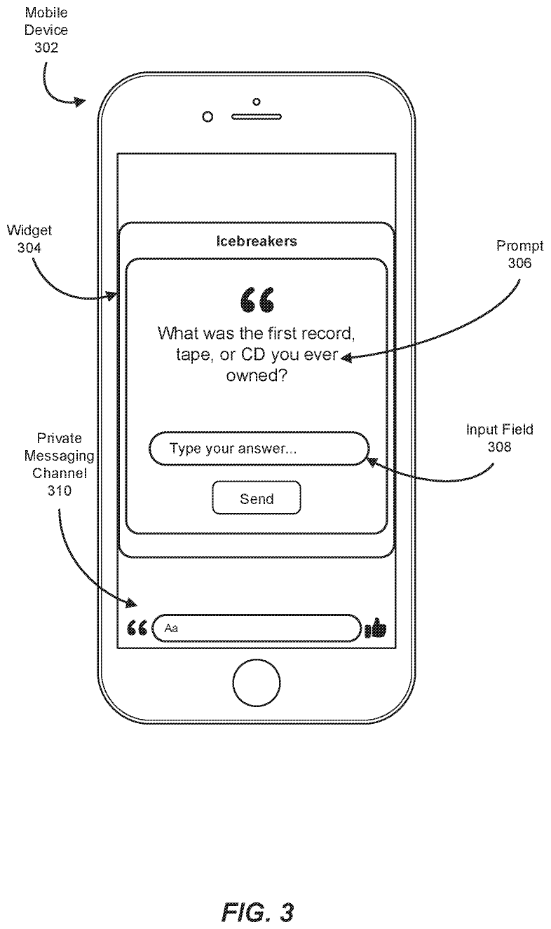

FIG. 3 is an illustration of an exemplary interactive ice breaker widget designed to facilitate conversations between matches in an online dating service. As shown in this figure, the systems described herein may present a widget 304 to a user via a mobile phone 302. In some embodiments, widget 304 may consist of several components. For example, widget 304 may include a prompt 306. In some embodiments, prompt 306 may be an open-ended question. Additionally or alternatively, widget 304 may include one or more images, animations (e.g., .gifs and/or videos), and/or other media that serve as a prompt to elicit a response from the user and/or potential match. For example, widget 304 may include an image of bell-bottom jeans with the caption “What's the worst style choice you've ever made?” Similarly, widget 304 may include a .gif or video clip of a man falling down with the caption “Share your most embarrassing moment!”

In some embodiments, the system described herein may select and/or customize prompt 306 automatically based on one or more characteristics of the user and/or the potential match. In some examples, the systems described herein may select and/or customize prompt 306 based on topic categories and/or other information on a dating profile and/or user profile of the user and/or the potential match. For example, if the user and/or potential match list music-related interests in their profile, the systems described herein may select or generate a music-related prompt. Additionally or alternatively, the systems described herein may select or generate the prompt based on interests indicated by the user and/or potential match in other ways, such as membership in an interest-based community. For example, if the user is a member of a group dedicated to posting pictures of dogs, the systems described herein may select or generate a prompt relevant to animals (e.g., “What's your favorite dog breed?”).

In some embodiments, widget 304 may include an input field 308 to enable the user to input a response to prompt 306. In some embodiments, input field 308 may be a text field that accepts freeform text input (i.e., as opposed to a checkbox and/or set of multiple-choice answers). Additionally or alternatively, input field 308 may enable the user to enter images, animations, and/or other media. In some embodiments, the systems described herein may present widget 304 via a private messaging channel 310 between the user and the potential match. In one embodiment, the systems described herein may only present widget 304 if no previous messages are present in private messaging channel 310 (i.e., no conversation has been initiated between the user and the potential match). Additionally or alternatively, the systems described herein may present widget 304 at any point during a conversation between a user and a potential match in response to a trigger, such as the user and/or potential match selecting the widget, a predetermined span of time passing with no messages between the user and the potential match, and/or any other suitable trigger.

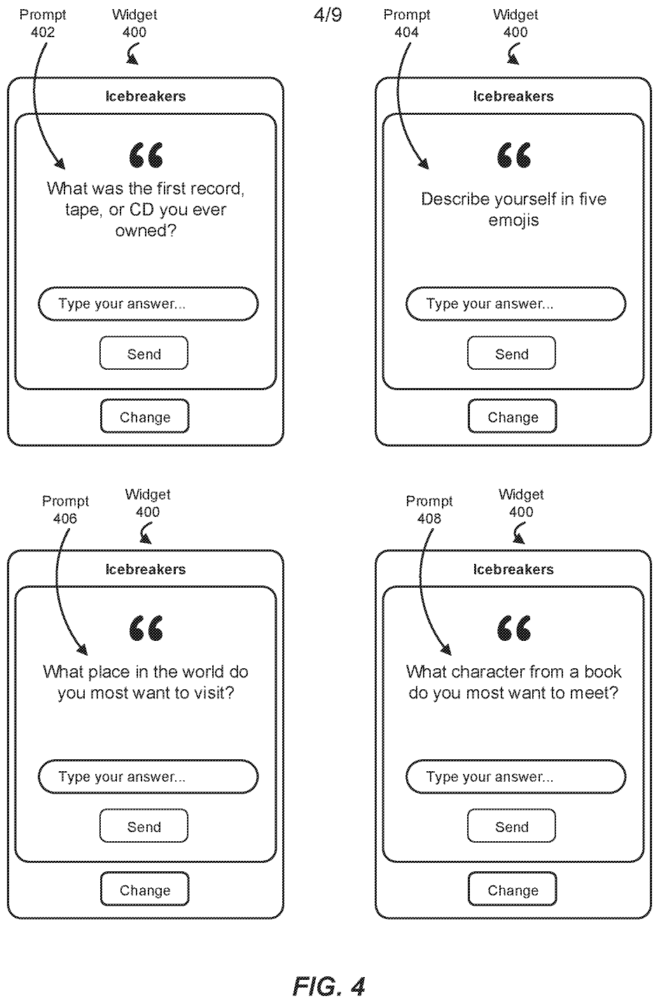

In some embodiments, the systems described herein may enable a user to select a prompt and/or widget from a set of prompts and/or widgets. For example, as illustrated in FIG. 4, a widget 400 may enable a user to select between a prompt 402, a prompt 404, a prompt 406, and/or a prompt 408. In some embodiments, the systems described herein may present a set of widgets and/or prompts to the user one at a time and may enable the user to browse through the set (e.g., by scrolling, hitting a button, etc.). For example, the system may first present prompt 402 to the user. If desired, the user may request a new prompt by selecting the “change” button. In response, the system may present prompt 404, prompt 406, etc. until the user has identified a desired prompt and entered their response. In some embodiments, once a user and/or potential match has responded to a prompt within a widget, the systems described herein may prevent the user from selecting a different prompt for that instance of the widget. In some embodiments, the systems described herein may present a user with prompts and/or widgets based at least in part on a characteristic of the user and/or the potential match. For example, the systems described herein may generate, select, and/or customize prompts based on categories of interest indicated by the user via profile information and/or group membership. For example, the systems described herein may generate, select, and/or customize prompts about music, travel, and/or literature based on interests indicated by both the user and the potential match. Additionally or alternatively, the systems described herein may select and/or generate generic prompts (e.g., “describe yourself in five emojis”) and/or arbitrary prompts (i.e., not selected based on any characteristic of the user and/or potential match).

In some embodiments, a widget may expire if a user has not responded to the widget within a set time period (e.g., one day, two days, one week, one month). For example, the widget may become unavailable (e.g., may no longer be presented to the user). In another example, the user may be replaced by an alternative widget and/or prompt. For example, the systems described herein may initially present a user with widget 400 with prompt 402. However, after two days has passed without the user responding to widget 400, the systems described herein may instead present the user with widget 400 with prompt 404. In some embodiments, a widget may expire if a user has responded to the widget but the potential match has not.

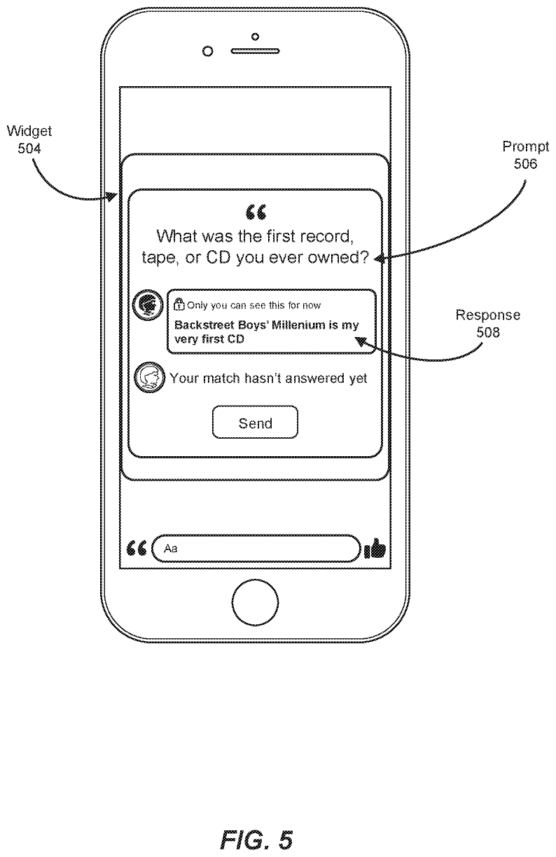

In some embodiments, the systems described herein may require the user to input a response into the widget before presenting the widget to the potential match. For example, as illustrated in FIG. 5, a widget 504 may include a prompt 506. In some examples, the user may input a response 508 to prompt 506 into widget 504. In one embodiment, widget 504 may store response 508 for display to the user and/or potential match.

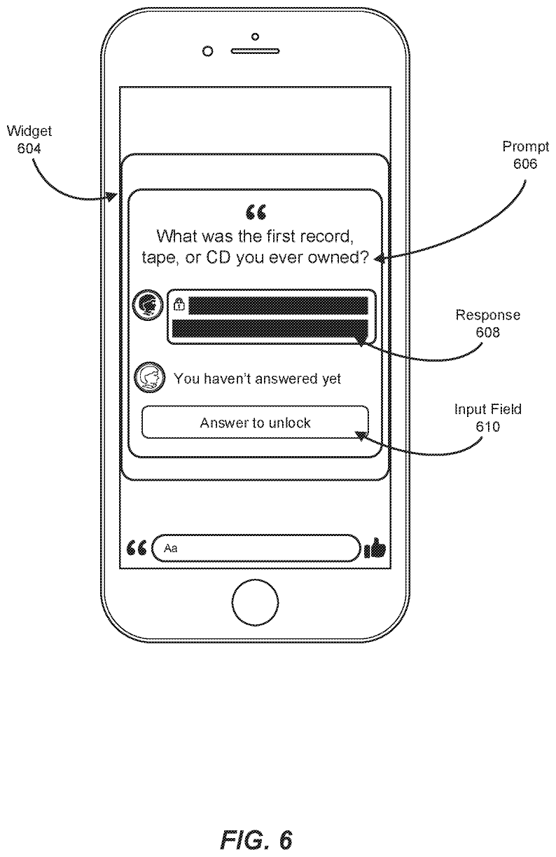

In some examples, a user's response to a prompt within a widget may not be visible to a potential match until the potential match answers the prompt within the widget. For example, as illustrated in FIG. 6, a user may have provided a response 608 to a widget 604. The systems described herein may then present widget 604 to a potential match on behalf of the user. In some examples, the systems described herein may display an indication that the user has provided a response to widget 604, but may display response 608 in an obscured form since the potential match has yet to answer prompt 606. In these examples, the systems described herein may indicate to the potential match that the user's response 608 will become visible only after the potential match has input a response (e.g., into an input field 610) and/or may indicate to the user that the potential match will not be able to see response 608 until the potential match has input a response into widget 604.

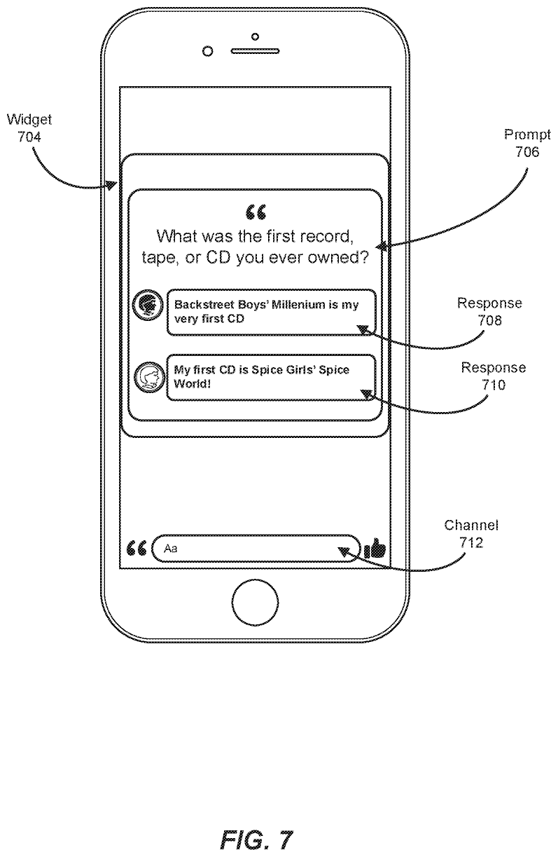

In some examples, after both the user and the potential match have entered responses into a widget, the widget may display both responses to both parties. For example, as illustrated in FIG. 7, a widget 704 may have a prompt 706 that has elicited a response 708 from the user and a response 710 from the potential match. Because both the potential match and the user have inputted responses to widget 704, widget 704 may display both response 708 and response 710 to both the user and the potential match. In some embodiments, the systems described herein may present widget 704 in a private communication channel 712 between the user and the potential match. In some examples, the user and the potential match may then begin a conversation about response 708, response 710, and/or prompt 706 via channel 712 in response to widget 704 displaying response 708 and/or response 710.

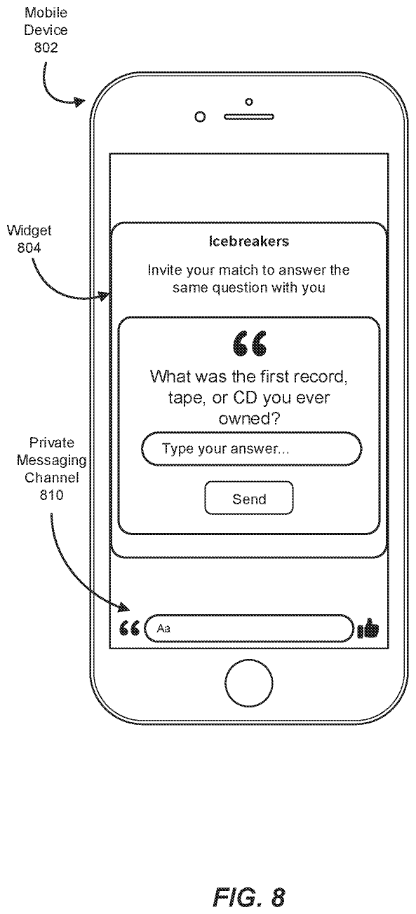

In some embodiments, the systems described herein may present a user with a customized interactive ice breaker widget and the option to present the widget to a potential match without first providing a response to the widget. For example, as illustrated in FIG. 8, the systems described herein may cause a mobile device 802 to display a widget 804. In some examples, the widget may be accompanied by text suggesting that the user invite the potential match to respond to the widget. In some embodiments, the systems described herein may present widget 804 via a private messaging channel 810 between the user and the potential match.

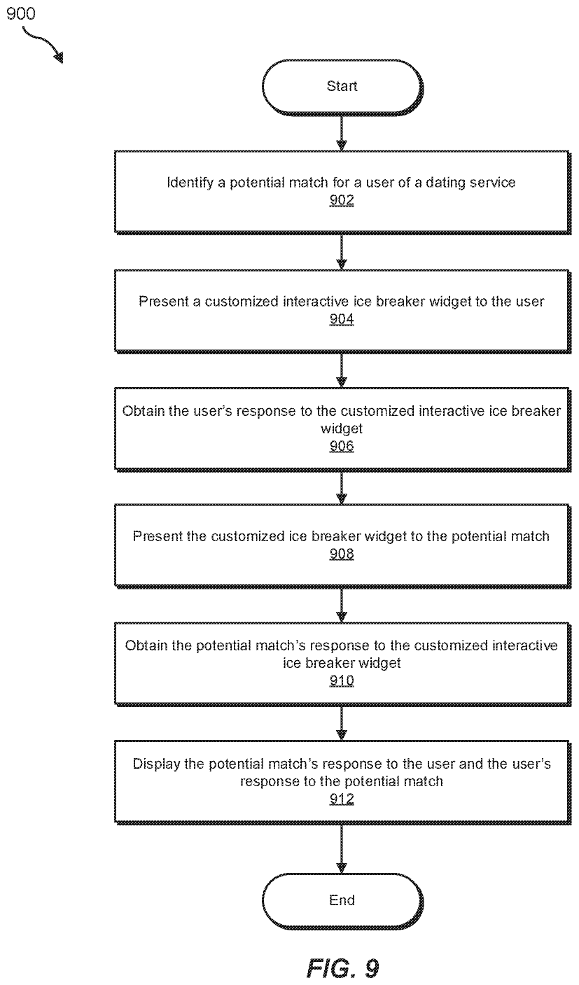

In some embodiments, the systems described herein may follow a predetermined flow when presenting widgets to users to initiate conversations. FIG. 9 is a flow diagram of an exemplary method 900 for initiating conversations within an online dating service. In some examples, at step 902, the systems described herein may identify a potential match for a user of a dating service. The systems described herein may identify the potential match in a variety of ways including mutual interests, mutual connections, mutually indicated interest in one another, and/or any other appropriate way. At step 904, the systems described herein may present a customized interactive ice breaker widget to the user. In some embodiments, the systems described herein may customize the ice breaker widget by selecting a prompt based on a characteristic of the user. At step 906, the systems described herein may obtain the user's response to the customized interactive ice breaker widget. For example, the systems described herein may obtain a text response. At step 908, the systems described herein may present the customized interactive ice breaker widget to the potential match. In some embodiments, the user's response may be obscured or otherwise hidden from the potential match until the potential match provides a response. At step 910, the systems described herein may obtain the potential match's response to the customized interactive ice breaker widget. For example, the systems described herein may obtain a text-based response from the potential match. At step 912, the systems described herein may display the potential match's response to the user and the user's response to the potential match. In some embodiments, some or all of the preceding steps may take place in a private communication channel viewable only by the user and the potential match.

As described above, the systems and methods described herein may generate and present an “ice breaker” message to potential matches in an online dating service. The ice breaker message may, for example, include an open-ended question or inquiry (e.g., “What was the first CD you ever owned?” or “Describe yourself in five emojis”) designed to encourage or facilitate conversation between potential matches. This ice breaker message may be customized based on shared characteristics of the matches (e.g., shared interests, groups, geographic location, age, etc.). In some cases, a participant may be required to respond to the ice breaker message before being permitted to view a potential match's response to the ice breaker message. There may additionally or alternatively be a time limit on the ice breaker message. By generating ice breaker messages for participants on a dating service to respond to, the systems and methods described herein may reduce the barrier to engaging in conversation, leading to a greater number of conversations and, potentially, dates, for participants in the dating service.

### Example Embodiments

Example 1: A computer-implemented method for initiating conversations within an online dating service may include identifying a potential match for a user of an online dating service, automatically generating, in response to identifying the potential match, a customized interactive ice breaker widget that is customized to facilitate conversation between the user and the potential match, presenting the customized interactive ice breaker widget to the user, obtaining the user's response to the customized interactive ice breaker widget, and presenting, to the potential match, both the customized interactive ice breaker widget and the user's response to the customized interactive ice breaker widget to facilitate conversation between the user and the potential match.

Example 2: The computer-implemented method of Example 1, where automatically generating the customized interactive ice breaker widget includes identifying a characteristic of at least one of the user or the potential match and customizing the customized interactive ice breaker widget based on the characteristic.

Example 3: The computer-implemented method of Examples 1 and 2, where automatically generating the customized interactive ice breaker widget includes automatically generating a set of customized interactive ice breaker widgets, presenting the set of customized interactive ice breaker widgets to the user, and determining that the user has selected the customized interactive ice breaker widget from the set of customized interactive ice breaker widgets.

Example 4:The computer-implemented method of any of Examples 1-3, where presenting the customized interactive ice breaker widget includes presenting the customized interactive ice breaker widget via a private messaging channel between the user and the potential match.

Example 5: The computer-implemented method of any of Examples 1-4, where presenting both the customized interactive ice breaker widget and the user's response to the customized interactive ice breaker widget includes presenting the customized interactive ice breaker widget to the potential match in response to receiving the user's response to the customized interactive ice breaker widget.

Example 6: The computer-implemented method of any of Examples 1-5, where presenting both the customized interactive ice breaker widget and the user's response to the customized interactive ice breaker widget includes presenting the customized interactive ice breaker widget to the potential match with the user's response hidden, receiving a response to the customized interactive ice breaker widget from the potential match, and revealing the user's response to the customized interactive ice breaker widget to the potential match in response to receiving the response from the potential match.

Example 7: The computer-implemented method of any of Examples 1-6, further including receiving a response to the customized interactive ice breaker widget from the potential match and presenting the response from the potential match to the user.

Example 8: The computer-implemented method of any of Examples 1-7, where the customized interactive ice breaker widget includes an open-ended question.

Example 9: The computer-implemented method of any of Examples 1-8, where the online dating service is at least one of a feature of a social network or a community-based dating service.

Example 10: A system may include at least one physical processor and physical memory comprising computer-executable instructions that, when executed by the physical processor, cause the physical processor to (1) identify a potential match for a user of an online dating service, (2) automatically generate, in response to identifying the potential match, a customized interactive ice breaker widget that is customized to facilitate conversation between the user and the potential match, (3) present the customized interactive ice breaker widget to the user, (4) obtain the user's response to the customized interactive ice breaker widget, and (5) present, to the potential match, both the customized interactive ice breaker widget and the user's response to the customized interactive ice breaker widget to facilitate conversation between the user and the potential match.

Example 11: The system of Example 10, where automatically generating the customized interactive ice breaker widget includes identifying a characteristic of at least one of the user or the potential match and customizing the customized interactive ice breaker widget based on the characteristic.

Example 12: The system of Examples 10 and 11, where automatically generating the customized interactive ice breaker widget includes automatically generating a set of customized interactive ice breaker widgets, presenting the set of customized interactive ice breaker widgets to the user, and determining that the user has selected the customized interactive ice breaker widget from the set of customized interactive ice breaker widgets.

Example 13: The system of Examples 10-12, where presenting the customized interactive ice breaker widget comprises presenting the customized interactive ice breaker widget via a private messaging channel between the user and the potential match.

Example 14: The system of Examples 10-13, where presenting both the customized interactive ice breaker widget and the user's response to the customized interactive ice breaker widget includes presenting, after identifying the potential match, the customized interactive ice breaker widget to both the user and the potential match simultaneously, presenting the customized interactive ice breaker widget to the potential match only after, and in response to, receiving a request from the user to send the customized interactive ice breaker widget to the potential match, or presenting the customized interactive ice breaker widget to the potential match only after, and in response to, receiving the user's response to the customized interactive ice breaker widget.

Example 15: The system of Examples 10-14, where the presenting both the customized interactive ice breaker widget and the user's response to the customized interactive ice breaker widget includes presenting the customized interactive ice breaker widget to the potential match with the user's response hidden, receiving a response to the customized interactive ice breaker widget from the potential match, and revealing the user's response to the customized interactive ice breaker widget to the potential match in response to receiving the response from the potential match.

Example 16: The system of Examples 10-15, where the computer-executable instructions that cause the physical processor to receive a response to the customized interactive ice breaker widget from the potential match and present the response from the potential match to the user.

Example 17: The system of Examples 10-16, where the customized interactive ice breaker widget includes an open-ended question.

Example 18: The system of Examples 10-17, where the online dating service includes at least one of a feature of a social network or a community-based dating service.

Example 19: A non-transitory computer-readable medium including one or more computer-readable instructions that, when executed by at least one processor of a computing device, cause the computing device to: (i) identify a potential match for a user of an online dating service, (ii) automatically generate, in response to identifying the potential match, a customized interactive ice breaker widget that is customized to facilitate conversation between the user and the potential match, (iii) present the customized interactive ice breaker widget to the user, (iv) obtain the user's response to the customized interactive ice breaker widget, and (v) present, to the potential match, both the customized interactive ice breaker widget and the user's response to the customized interactive ice breaker widget to facilitate conversation between the user and the potential match.

Example 20: The non-transitory computer-readable medium of Example 19, where automatically generating the customized interactive ice breaker widget includes identifying a characteristic of at least one of the user or the potential match and customizing the customized interactive ice breaker widget based on the characteristic.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying a potential match for a user of an online dating service;
automatically generating, in response to identifying the potential match, a customized interactive ice breaker widget that is customized to facilitate conversation between the user and the potential match;
presenting the customized interactive ice breaker widget to the user;
obtaining the user's response to the customized interactive ice breaker widget; and
presenting, to the potential match, both the customized interactive ice breaker widget and the user's response to the customized interactive ice breaker widget to facilitate conversation between the user and the potential match.

2. The computer-implemented method of claim 1, wherein automatically generating the customized interactive ice breaker widget comprises:
identifying a characteristic of at least one of the user or the potential match; and
customizing the customized interactive ice breaker widget based on the characteristic.

3. The computer-implemented method of claim 1, wherein automatically generating the customized interactive ice breaker widget comprises:
automatically generating a set of customized interactive ice breaker widgets;
presenting the set of customized interactive ice breaker widgets to the user; and
determining that the user has selected the customized interactive ice breaker widget from the set of customized interactive ice breaker widgets.

4. The computer-implemented method of claim 1, wherein presenting the customized interactive ice breaker widget comprises presenting the customized interactive ice breaker widget via a private messaging channel between the user and the potential match.

5. The computer-implemented method of claim 1, wherein presenting the customized interactive ice breaker widget to the potential match comprises at least one of:
presenting, after identifying the potential match, the customized interactive ice breaker widget to both the user and the potential match simultaneously;
presenting the customized interactive ice breaker widget to the potential match only after, and in response to, receiving a request from the user to send the customized interactive ice breaker widget to the potential match; or
presenting the customized interactive ice breaker widget to the potential match only after, and in response to, receiving the user's response to the customized interactive ice breaker widget.

6. The computer-implemented method of claim 1, wherein presenting, to the potential match, both the customized interactive ice breaker widget and the user's response to the customized interactive ice breaker widget comprises:
presenting the customized interactive ice breaker widget to the potential match with the user's response hidden;
receiving a response to the customized interactive ice breaker widget from the potential match; and
revealing the user's response to the customized interactive ice breaker widget to the potential match only after, and in response to, receiving the response from the potential match.

7. The computer-implemented method of claim 1, further comprising:
receiving a response to the customized interactive ice breaker widget from the potential match; and
presenting the response from the potential match to the user.

8. The computer-implemented method of claim 1, wherein the customized interactive ice breaker widget comprises an open-ended question.

9. The computer-implemented method of claim 1, wherein the online dating service comprises at least one of a feature of a social network or a community-based online dating service.

10. A system comprising:
at least one physical processor;
physical memory comprising computer-executable instructions that, when executed by the physical processor, cause the physical processor to:
identify a potential match for a user of an online dating service;
automatically generate, in response to identifying the potential match, a customized interactive ice breaker widget that is customized to facilitate conversation between the user and the potential match;
present the customized interactive ice breaker widget to the user;
obtain the user's response to the customized interactive ice breaker widget; and
present, to the potential match, both the customized interactive ice breaker widget and the user's response to the customized interactive ice breaker widget to facilitate conversation between the user and the potential match.

11. The system of claim 10, wherein automatically generating the customized interactive ice breaker widget comprises:
identifying a characteristic of at least one of the user or the potential match; and
customizing the customized interactive ice breaker widget based on the characteristic.

12. The system of claim 10, wherein automatically generating the customized interactive ice breaker widget comprises:
automatically generating a set of customized interactive ice breaker widgets;
presenting the set of customized interactive ice breaker widgets to the user; and
determining that the user has selected the customized interactive ice breaker widget from the set of customized interactive ice breaker widgets.

13. The system of claim 10, wherein presenting the customized interactive ice breaker widget comprises presenting the customized interactive ice breaker widget via a private messaging channel between the user and the potential match.

14. The system of claim 10, wherein presenting both the customized interactive ice breaker widget and the user's response to the customized interactive ice breaker widget comprises:
presenting, after identifying the potential match, the customized interactive ice breaker widget to both the user and the potential match simultaneously;
presenting the customized interactive ice breaker widget to the potential match only after, and in response to, receiving a request from the user to send the customized interactive ice breaker widget to the potential match; or
presenting the customized interactive ice breaker widget to the potential match only after, and in response to, receiving the user's response to the customized interactive ice breaker widget.

15. The system of claim 10, wherein presenting both the customized interactive ice breaker widget and the user's response to the customized interactive ice breaker widget comprises:
presenting the customized interactive ice breaker widget to the potential match with the user's response hidden;
receiving a response to the customized interactive ice breaker widget from the potential match; and
revealing the user's response to the customized interactive ice breaker widget to the potential match in response to receiving the response from the potential match.

16. The system of claim 10, further comprising computer-executable instructions that cause the physical processor to:
receive a response to the customized interactive ice breaker widget from the potential match; and
present the response from the potential match to the user.

17. The system of claim 10, wherein the customized interactive ice breaker widget comprises an open-ended question.

18. The system of claim 10, wherein the online dating service comprises at least one of a feature of a social network or a community-based dating service.

19. A non-transitory computer-readable medium comprising one or more computer-readable instructions that, when executed by at least one processor of a computing device, cause the computing device to:
identify a potential match for a user of an online dating service;
automatically generate, in response to identifying the potential match, a customized interactive ice breaker widget that is customized to facilitate conversation between the user and the potential match;
present the customized interactive ice breaker widget to the user;
obtain the user's response to the customized interactive ice breaker widget; and
present, to the potential match, both the customized interactive ice breaker widget and the user's response to the customized interactive ice breaker widget to facilitate conversation between the user and the potential match.

20. The non-transitory computer-readable medium of claim 19, wherein automatically generating the customized interactive ice breaker widget comprises:
identifying a characteristic of at least one of the user or the potential match; and
customizing the customized interactive ice breaker widget based on the characteristic.
